(19) United States
(12) Patent Application Publication
(10) Pub. No.: US 2004/0160288 A1
(43) Pub. Date: Aug. 19, 2004

(54) Isolator suitable for miniaturization

(75) Inventor: Takamitsu Shibayama, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/780,174

(22) Filed: Feb. 17, 2004

(30) Foreign Application Priority Data
Feb. 19, 2003 (JP) 2003-040438

(51) Int. Cl. H01P 1/36

(52) U.S. Cl. 333/24.2

(57) ABSTRACT

An isolator suitable for miniaturization due to a reduction in the size of a capacitor is provided. The isolator includes a flat plate-shaped ferrite member 4, and first, second, and third central conductors 5, 6, and 7 arranged on different planes in a vertical direction with dielectric bodies sandwiched therebetween so that parts thereof cross each other in the vertical direction. The ferrite member 4 is of a rectangle with long sides 4a and short sides 4b. One of the central conductors is located on the long side 4a and is arranged so as to transverse the short surface of the ferrite member 4 at an oblique angle to the short sides 4b. Therefore, the length of the central conductor increases, thereby increasing the inductance component. As a result, it is possible to reduce the size of the capacitor for performing resonance and to thus miniaturize the isolator.

### BACKGROUND OF THE INVENTION

1. Field of the Invention

The present invention relates to an isolator applied to an antenna combiner.

2. Description of the Related Art

A conventional isolator will now be described with reference to the accompanying drawings. FIG. 8 is an exploded perspective view of a conventional isolator. FIG. 9 is a plan view of main parts of the conventional isolator. FIG. 10 is a development view of central conductors related to the conventional isolator.

The structure of the conventional isolator will now be described with reference to FIGS. 8 to 10. The conventional isolator includes a boxlike first yoke 51, a disc-like magnet 52 arranged in the first yoke 51, a flat plate-shaped ferrite member 53 arranged under the magnet 52, first, second, and third central conductors 54, 55, and 56 made of a metal plate, which are mounted to the ferrite member 53 at intervals of 120° and parts of which cross each other, a boxlike resin case 57 that holds the ferrite member 53, and a U-shaped second yoke 58 arranged under the resin case 57.

The ferrite member 53 is of a rectangle having two long sides 53a opposite to each other and two short sides 53b opposite to each other.

As illustrated in FIG. 10, the first, second, and third central conductors 54, 55, and 56 are formed by punching a metal plate and are formed to extend outward from a square earth 70 provided in the center.

The first, second, and third central conductors 54, 55, and 56 are divided into two by slits 54a, 55a, and 56a provided in their longitudinal directions, respectively. The first, second, and third central conductors 54, 55, and 56 also have conductors 54b, 55b, and 56b, each consisting of two streaks of conductors having the same width and parallel to each other, and first, second, and third ports 54c, 55c, and 56c provided at the ends of the conductors 54b, 55b, and 56b.

Further, the first, second, and third central conductors 54, 55, and 56 are arranged such that the earth 70 is first arranged on the bottom face of the ferrite member 53, and the first, second, and third central conductors 54, 55, and 56 are then bent along the side face and top face of the ferrite member 53.

Although not illustrated herein, the first, second, and third central conductors 54, 55, and 56 located on the top face of the ferrite member 53 are arranged in a vertical direction in a state of being insulated from each other by dielectric bodies.

When the first, second, and third central conductors 54, 55, and 56 are mounted to the ferrite member 53, the first and second central conductors 54 and 55 are located on the short sides 53b and are arranged to cross the long surface of the ferrite member 53. The third central conductor 56 is located on the long side 53a and is arranged so as to transverse the short surface of the ferrite member 53 parallel to the short side 53b.

Further, the resin case 57 is provided with a bottom wall 57b having a hole 57a. Input and output terminals 59 and 60 and an earth terminal 61 are buried in the bottom wall 57b in a state where parts thereof are exposed to the outsides of the bottom wall 57b and the resin case 57.

The ferrite member 53 to which the first, second, and third central conductors 54, 55, and 56 are attached is arranged in the hole 57a so that the earth 70 at one end of each of the first, second, and third central conductors 54, 55, and 56 is connected to the second yoke 58.

Chip-type capacitors 62, 63, and 64 and a chip-type resistor 65 are arranged around the hole 57a so that electrodes on the bottom faces of the capacitors 62, 63, and 64 and an electrode 65a at one end of the resistor 65 are connected to the earth terminal 61.

The ports 54c and 55c of the first and second central conductors 54 and 55 are soldered to electrodes on the top faces of the capacitors 62 and 63. Further, the port 56c of the third central conductor 56 is connected to an electrode on the top face of the capacitor 64 and the top face of an electrode 65b at the other end of the resistor 65 by soldering.

The first and second yokes 51 and 58 are combined with each other in a state where the magnet 52, the ferrite member 53, and the resin case 57 are sandwiched between the first yoke 51 and the second yoke 58 so that a magnetic closed circuit is formed by the first and second yokes 51 and 58. Therefore, an isolator is formed (For example, refer to the Patent Document 1).

However, since the third central conductor 56 of a conventional isolator is provided on the long side 53a and is arranged so as to transverse the short surface of the ferrite member 53 parallel to the short sides 53b, the third central conductor 56 has a small inductance component. Therefore, it is necessary to increase the size of the capacitor 64 and to thus increase the size of the isolator.

[Patent Document 1]

Japanese Unexamined Patent Application Publication No. 2001-94311

In a conventional isolator, since the third central conductor 56 is provided on the long side 53a and is arranged so as to transverse the short surface of the ferrite member 53 parallel to the short sides 53b, the length of the third central conductor 56 is reduced. Therefore, the third central conductor 56 has a small inductance component. As a result, it is necessary to increase the size of the capacitor 64 and to thus increase the size of the isolator.

### SUMMARY OF THE INVENTION

It is therefore an object of the present invention is to provide an isolator suitable for miniaturization due to a reduction in the size of a capacitor.

As first means for achieving the object, there is provided an isolator, comprising a flat plate-shaped ferrite member, first, second, and third central conductors located on the ferrite member on different planes in a vertical direction with dielectric bodies sandwiched therebetween so that parts thereof cross each other in the vertical direction, a magnet arranged on the central conductors, a first yoke arranged so as to cover the magnet, and a second yoke arranged on the bottom face of the ferrite member to constitute a magnetic closed circuit together with the first yoke. The ferrite member is of a rectangle with long sides and short sides. One of the central conductors is located on the long side and is arranged so as to transverse the short surface of the ferrite member at an oblique angle to the short sides.

Further, as second means for achieving the object, the central conductor arranged so as to transverse the short surface of the ferrite member is longitudinally divided to form first and second conductors.

Further, as third means for achieving the object, the first and second conductors are formed so as to have different angles so that the first and second conductors are not parallel to each other.

Further, as fourth means for achieving the object, the first and second conductors are arranged so as to be oriented at different angles with respect to the short sides.

Further, as fifth means for achieving the object, the first and second conductors have different widths.

Further, as sixth means for achieving the object, ports are provided at the ends of the first and second conductors, and a resistor and a capacitor are connected to the ports.

Further, as seventh means for achieving the object, the isolator comprises the first and second central conductors located on the short sides of the ferrite member and the third central conductor provided on the long side. The first and second central conductors are arranged so as to transverse the long surface of the ferrite member, and the third central conductor is arranged so as to transverse the short surface. Therefore, it is possible to reduce the size of the capacitor for performing resonance and to thus miniaturize the isolator.

Further, as eighth means for achieving the object, the isolator comprises cut-away portions provided at the corners of the ferrite member, the first and second central conductors located in the cut-away portions, and the third conductor located on the long side. The first and second central conductors located in the cut-away portions cross the ferrite member between the diagonally opposite cut-away portions, and the third central conductor is arranged to transverse the short surface.

### BRIEF DESCRIPTION OF THE DRAWINGS

FIG. 1 is an exploded perspective view of an isolator according to a first embodiment of the present invention;

FIG. 2 is a plan view of main parts of the isolator according to the first embodiment of the present invention;

FIG. 3 is a development view of central conductors of the isolator according to the first embodiment of the present invention;

FIG. 4 is an enlarged plan view of main parts of an isolator according to a second embodiment of the present invention;

FIG. 5 is an enlarged plan view of main parts of an isolator according to a third embodiment of the present invention;

FIG. 6 is an enlarged plan view of main parts of an isolator according to a fourth embodiment of the present invention;

FIG. 7 is an equivalent circuit diagram of an isolator according to the present invention.

FIG. 8 is an exploded perspective view of a conventional isolator;

FIG. 9 is a plan view of main parts of the conventional isolator; and

FIG. 10 is a development view of central conductors of the conventional isolator.

### DESCRIPTION OF THE PREFERRED EMBODIMENT

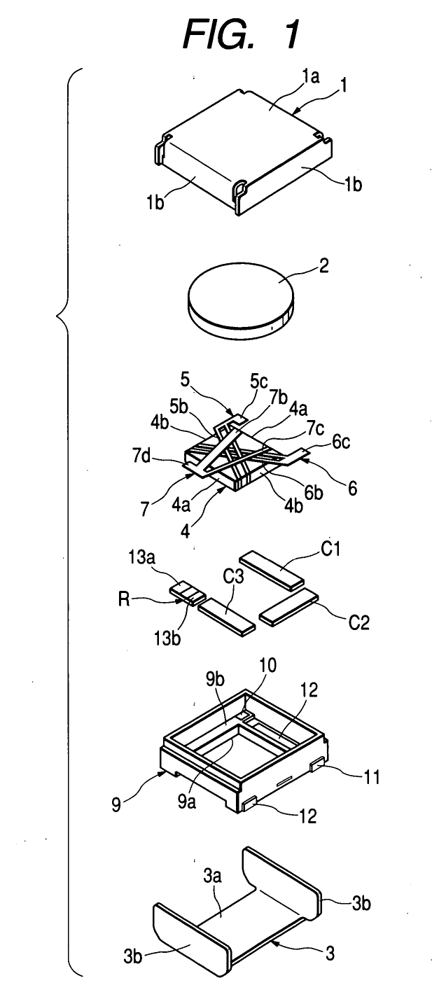

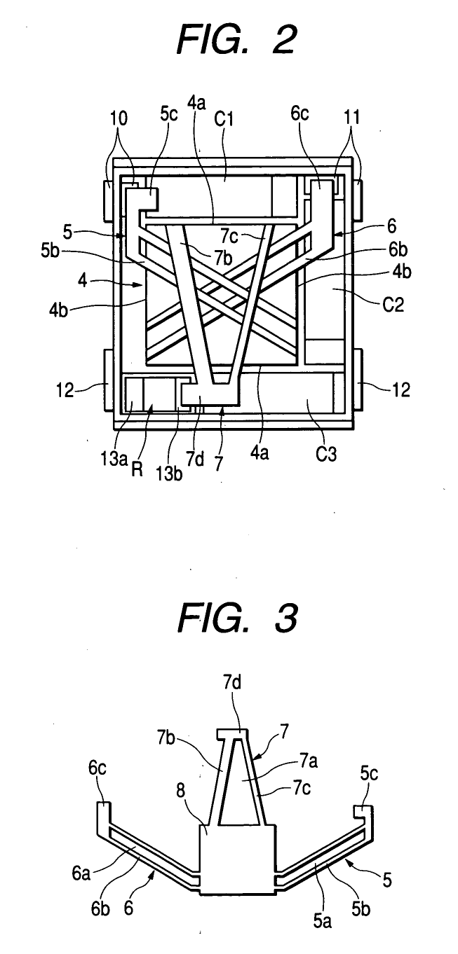

An isolator according to the present invention will now be described. FIG. 1 is an exploded perspective view of an isolator according to a first embodiment of the present invention. FIG. 2 is a plan view of main parts of the isolator according to the first embodiment of the present invention. FIG. 3 is a development view of central conductors of the isolator according to the first embodiment of the present invention.

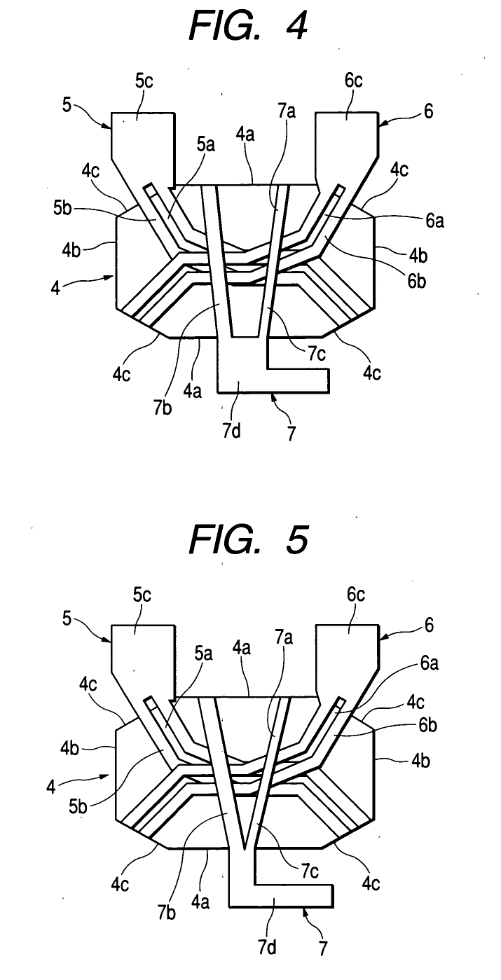

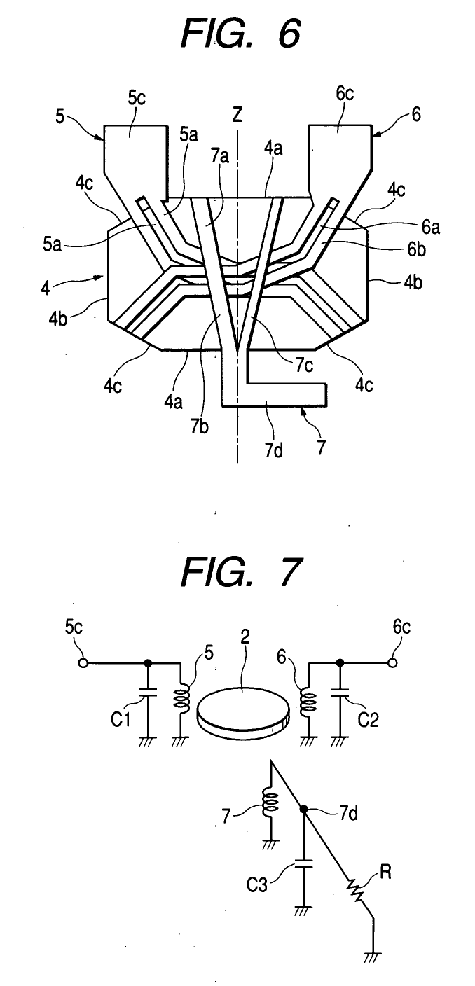

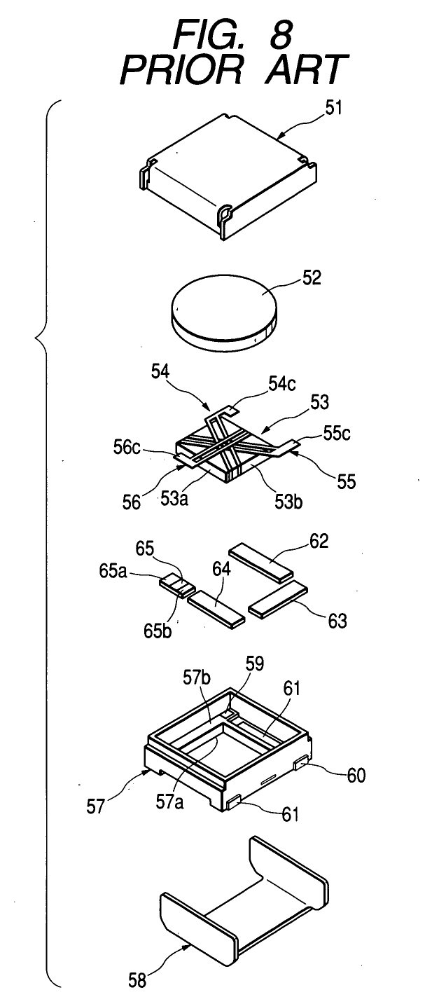

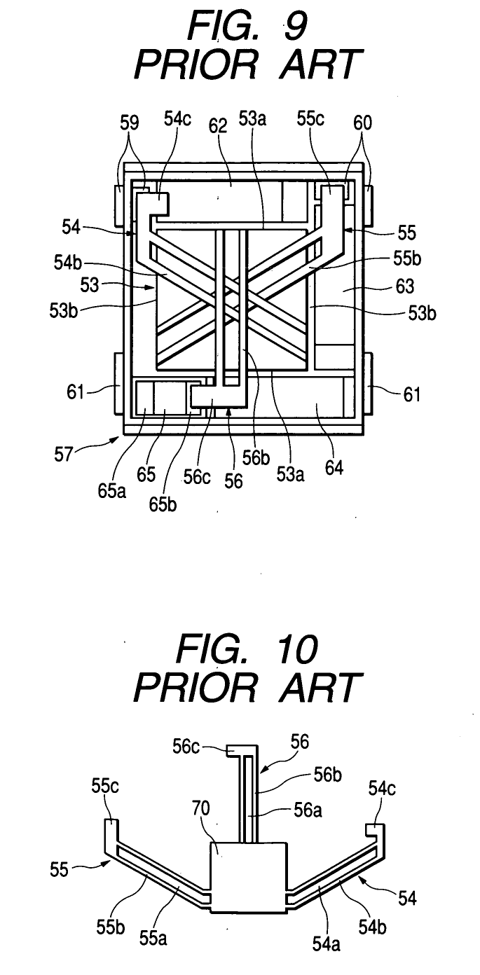

FIG. 4 is an enlarged plan view of main parts of an isolator according to a second embodiment of the present invention. FIG. 5 is an enlarged plan view of main parts of an isolator according to a third embodiment of the present invention. FIG. 6 is an enlarged plan view of main parts of an isolator according to a fourth embodiment of the present invention. FIG. 7 is an equivalent circuit diagram of the isolator according to the present invention.

The structure of the isolator according to the first embodiment of the present invention will now be described with reference to FIGS. 1 to 3. A first yoke 1 made of a boxlike magnetic plate (iron plate) has a square top plate 1a and side plates 1b bent downward from the four sides of the top plate 1a.

A disc-like magnet 2 is mounted on the first yoke 1 by appropriate means in a state where the top face thereof comes in contact with the inside of the top plate 1a.

A second yoke 3 made of a U-shaped magnetic plate (iron plate) has a rectangular bottom plate 3a and a pair of opposite side plates, which are bent upward from the opposite sides of the bottom plate 3a.

The second yoke 3 is arranged such that the pair of side plates 3b thereof are combined with the pair of side plates 1b of the first yoke 1 in a state where the bottom plate 3a thereof face the top plate 1a, thereby forming a magnetic closed circuit.

A flat plate-shaped ferrite member 4 made of yttrium iron garnet (YIG) or the like is of a rectangle having two long sides 4a that face each other and two short sides 4b that face each other.

As illustrated in FIG. 3, first, second, and third central conductors 5, 6, and 7 made of thin conductive plates such as copper plates are formed by punching a metal plate having holes and are formed to extend outward from a central rectangular earth 8.

The first and second central conductors 5 and 6 are divided into two by slits 5a and 6a provided in their longitudinal directions. The first and second central conductors 5 and 6 also has conductors 5b and 6b, each consisting of two streaks of conductors having the same width and parallel to each other, and first and second ports 5c and 6c provided at the ends of the conductors 5b and 6b.

Further, the third central conductor 7 is divided into two by a substantially V-shaped slit 7a provided in its longitudinal direction. The third central conductor 7 also has two streaks of first and second conductors 7b and 7c with different widths in a state where the pair of conductors 7b and 7c are not parallel to each other, and a third port 7d provided at the ends of the first and second conductors 7b and 7c.

Further, the first, second, and third central conductors 5, 6, and 7 are arranged such that the earth 8 is first arranged on the bottom face of the ferrite member 4 and the first, second, and third central conductors 5, 6, and 7 are bent along the sides and the top face of the ferrite member 4.

At this time, the first, second, and third central conductors 5, 6, and 7 are provided on different planes in a vertical direction at intervals of 120° with dielectric bodies (not illustrated) sandwiched therebetween so that parts thereof cross each other in the vertical direction.

When the first, second, and third central conductors 5, 6, and 7 are mounted on the ferrite member 4, the first and second central conductors 5 and 6 are located on the short sides 4b of the ferrite member 4 and are arranged to transverse the long surface of the ferrite member 4. Further, the third central conductor 7 is located on the long side 4a of the ferrite member 4 and is arranged to transverse the short surface of the ferrite member 4 at an oblique angle to the short sides 4b.

That is, since the first and second conductors 7b and 7c of the central conductor 7 are arranged so as to transverse the short surface of the ferrite member 4 at an oblique angle to the short sides 4b of the ferrite member 4, the length of the third central conductor 3 arranged so as to transverse the short surface of the ferrite member 4 increases compared to the conventional configuration. Therefore, it is possible to increase the inductance component.

Further, a resin case 9 is provided with a bottom wall 9b having a hole 9a. Further, input and output terminals 10 and 11 and an earth terminal 12 are buried in the bottom wall 9b in a state where parts thereof are exposed to the outsides of the bottom wall 9b and the resin case 9.

When the ferrite member 4 to which the first, second, and third central conductors 5, 6, and 7 are attached is arranged in the hole 9a, the earth 8 at one end of each of the first, second, and third central conductors 5, 6, and 7 is connected to the bottom wall 3b of the second yoke 3 arranged under the resin case 9.

Chip-type first, second, and third capacitors C1, C2, and C3 and a chip-type resistor R are arranged around the hole 9a so that electrodes on the bottom faces of the first, second, and third capacitors C1, C2, and C3 and an electrode 13a at one end of the resistor R are connected to the earth terminal 12.

The first and second ports 5c and 6c of the first and second central conductors 5 and 6 are soldered to electrodes on the top faces of the first and second capacitors C1 and C2. Further, the third port 7d of the third central conductor 7 is connected to an electrode on the top face of the third capacitor C3 and the top face of an electrode 13b at the other end of the resistor R by soldering.

The first and second yokes 1 and 3 are combined with each other in a state where the magnet 2, the ferrite member 4, and the resin case 9 are sandwiched between the first yoke 1 and the second yoke 3 so that a magnetic closed circuit is formed by the first and second yokes 1 and 3. As a result, an isolator is formed.

FIG. 7 illustrates an equivalent circuit diagram of the isolator according to the present invention. The first and second ports 5c and 6c, serving as input and output terminals, to which the grounded first and second capacitors C1 and C2 are connected, are provided at one end of each of the first and second central conductors 5 and 6. Further, the third port 7d to which the ground third capacitor C3 and resistor are connected is provided at one end of the third central conductor 7.

The other ends of the first, second, and third central conductors 5, 6, and 7 are grounded by the earth 8.

In the above embodiment, the widths of the first and second conductors 7b and 7c of the third central conductor 7 are different from each other. However, the widths of the first and second conductors 7b and 7c of the third central conductor 7 may be equal to each other.

Further, the first and second conductors 7b and 7c are not parallel to each other. However, the first and second conductors 7b and 7c may be parallel to each other.

Further, in the above embodiment, the third central conductor 7 consists of two streaks of first and second conductors 7b and 7c. However, the third central conductor 7 may consist of one streak of band-shaped conductor.

FIG. 4 illustrates the structure of an isolator according to a second embodiment of the present invention. The second embodiment will now be described. Cut-away portions 4c are provided at the corners of the rectangular ferrite member 4. The first and second central conductors 5 and 6 are arranged to transverse the ferrite member 4 between the cut-away portions 4c diagonally opposite to each other in a state of being located in the cut-away portions 4c. The third central conductor 7 is arranged on the long side 4a so as to transverse the short surface.

The conductors 5b and 6b of the first and second central conductors 5 and 6 are curved. Further, the first and second ports 5c and 6c provided at the ends of the first and second central conductors 5 and 6 are arranged along one long side 4a. The first and second conductors 7b and 7c of the third central conductor 7 are formed such that the distance therebetween is slightly larger.

FIG. 5 illustrates the structure of an isolator according to a third embodiment of the present invention. The third embodiment will now be described. Cut-away portions 4c are provided at the corners of the rectangular ferrite member 4. The first and second central conductors 5 and 6 are arranged in the cut-away portions 4c so as to transverse the ferrite member 4 between the cut-away portions 4c diagonally opposite to each other. Further, the third central conductor 7 is arranged on the long side 4a so as to transverse the short surface.

The conductors 5b and 6b of the first and second central conductors 5 and 6 are curved. Further, the first and second ports 5c and 6c provided at the ends of the first and second central conductors 5 and 6 are arranged along one long side 4a. The first and second conductors 7b and 7c of the third central conductor 7 are formed such that the distance therebetween is slightly smaller.

FIG. 6 illustrates an isolator according to a fourth embodiment of the present invention. The fourth embodiment will now be described. The first and second conductors 7b and 7c of the third central conductor 7 are formed such that the distance therebetween is slightly smaller. The first and second conductors 7b and 7c are arranged so as to have different inclinations with respect to a central line Z.

Accordingly, the first and second conductors 7b and 7c are arranged so as to have different inclinations with respect to the short side 4b of the ferrite member 4.

Other structure of the isolator according to the fourth embodiment is the same as the structure of the third embodiment excluding the above. The same parts are denoted by the same reference numerals. Therefore, detailed description thereof will be omitted.

The impedances of the first central conductor 5 and the second central conductor 6 are determined by the distances from the ferrite member 4 to the first central conductor 5 and the second central conductor 6 in the direction of the thickness of the ferrite member 4 and the angle at which the port of the first central conductor 5 or the second central conductor 6 crosses the third central conductor 7.

When the first, second, and third central conductors 5, 6, and 7 sequentially cross each other on the ferrite member 4, the distance between the ferrite member 4 and the first central conductor 5 is smaller than the distance between the ferrite member 4 and the second central conductor 6. Therefore, the inductance increases, thereby increasing the impedance of the first central conductor 5.

When the angles at which the first central conductor 5 and the second central conductor 6 cross the third central conductor 7 are equal to each other, the impedance of the first central conductor 5 is different from the impedance of the second central conductor 6.

As described in the fourth embodiment, it is possible to control the impedance by changing the angle at which the first and second conductors 7b and 7c of the third central conductor 7 face each other thereby changing the angle at which the port of the first central conductor 5 crosses the first conductor 7b of the third central conductor 7 and the angle at which the port of the second central conductor 6 crosses the second conductor 7c of the third central conductor 7.

The isolator according to the present invention includes a flat plate-shaped ferrite member, first, second, and third central conductors located on the ferrite member on different planes in a vertical direction with dielectric bodies sandwiched therebetween so that parts thereof cross each other in the vertical direction, a magnet arranged on the central conductors, a first yoke arranged to cover the magnet, and a second yoke arranged on the bottom face of the ferrite member so as to constitute a magnetic closed circuit together with the first yoke. The ferrite member is of a rectangle with long sides and short sides. One of the central conductors is located on the long side and is arranged so as to transverse the short surface of the ferrite member at an oblique angle to the short sides.

As mentioned above, one of the central conductors is located on the long side and is arranged so as to transverse the short surface of the ferrite member at an oblique angle to the short sides. Thus, the length of the central conductor increases, thereby increasing the inductance component thereof. As a result, it is possible to reduce the size of the capacitor for performing resonance and to thus miniaturize the isolator.

Further, the central conductor arranged so as to transverse the short surface of the ferrite member is longitudinally divided to form first and second conductors. Thus, it is possible to secure a well-balanced position in consideration of the positions of the other two central conductors.

Further, the first and second conductors are arranged so as to be oriented at different angles with respect to the short sides. Thus, it is possible to control the angles of the central conductors, respectively. As a result, it is possible to correct the difference in the impedances due to the difference in the lengths of the central conductors when the three central conductors cross each other.

Further, the first and second conductors have different widths. Thus, it is possible to increase the width of one conductor. As a result, it is possible to increase the bending strength of the central conductor.

Further, the ports are provided at the ends of the first and second conductors, and the resistor and the capacitor are connected to the ports. Thus, it is possible to reduce the size of the capacitor for performing resonance and to obtain an appropriate isolator.

Further, the isolator comprises the first and second central conductors located on the short sides of the ferrite member and the third central conductor provided on the long side. The first and second central conductors are arranged so as to transverse the long surface of the ferrite member, and the third central conductor is arranged so as to transverse the short surface. Thus, it is possible to reduce the size of the capacitor for performing resonance and to miniaturize the isolator.

Further, the isolator comprises cut-away portions provided at the corners of the ferrite member, the first and second central conductors located in the cut-away portions, and the third conductor located on the long side. The first and second central conductors located in the cut-away portions cross the ferrite member between the diagonally opposite cut-away portions, and the third central conductor is arranged to transverse the short surface. Thus, it is possible to reduce the size of the capacitor for performing resonance and to thus miniaturize the isolator.

What is claimed is:

1. An isolator, comprising:
a flat plate-shaped ferrite member;
first, second, and third central conductors located on the ferrite member on different planes in a vertical direction with dielectric bodies sandwiched therebetween so that parts thereof cross each other in the vertical direction;
a magnet arranged on the central conductors;
a first yoke arranged so as to cover the magnet; and
a second yoke arranged on the bottom face of the ferrite member to constitute a magnetic closed circuit together with the first yoke,
wherein the ferrite member is of a rectangle having long sides and short sides, and
wherein one of the central conductors is located on the long side and is arranged so as to transverse the short surface of the ferrite member at an oblique angle to the short sides.

2. The isolator according to claim 1, wherein the central conductor arranged so as to transverse the short surface of the ferrite member is longitudinally divided to form first and second conductors.

3. The isolator according to claim 2, wherein the first and second conductors are formed so as to have different angles so that the first and second conductors are not parallel to each other.

4. The isolator according to claim 3, wherein the first and second conductors are arranged so as to be oriented at different angles with respect to the short sides.

5. The isolator according to claim 2, wherein the first and second conductors have different widths.

6. The isolator according to claim 2, wherein ports are provided at the ends of the first and second conductors, and a resistor and a capacitor are connected to the ports.

7. The isolator according to claim 1, comprising:
the first and second central conductors located on the short sides of the ferrite member; and
the third central conductor provided on the long side,
wherein the first and second central conductors are arranged so as to transverse the long surface of the ferrite member, and
wherein the third central conductor is arranged so as to transverse the short surface.

8. The isolator according to claim 1, comprising:
cut-away portions provided at the corners of the ferrite member,
the first and second central conductors located in the cut-away portions, and
the third conductor located on the long side,
wherein the first and second central conductors located in the cut-away portions cross the ferrite member between the diagonally opposite cut-away portions, and
wherein the third central conductor is arranged to transverse the short surface.
